(19) United States
(12) Patent Application Publication
(10) Pub. No.: US 2025/0242583 A1
(43) Pub. Date: Jul. 31, 2025

(54) PRINTING APPARATUS, PRINTING METHOD, AND STORAGE MEDIUM

(71) Applicant: CANON KABUSHIKI KAISHA, Tokyo (JP)

(72) Inventors: TATSUHIRO YAMAGATA, Tokyo (JP); OKINORI TSUCHIYA, Kanagawa (JP); TAKASHI FUJITA, Tokyo (JP); HIROMITSU YAMAGUCHI, Kanagawa (JP); AKITOSHI YAMADA, Kanagawa (JP); HIDETSUGU KAGAWA, Kanagawa (JP)

(21) Appl. No.: 19/040,733

(22) Filed: Jan. 29, 2025

(30) Foreign Application Priority Data
Jan. 31, 2024 (JP) 2024-013721

(51) Int. Cl. B41J 2/045; B41J 2/155; B41J 3/44; B41J 11/00; B41J 29/00

(52) U.S. Cl. CPC B41J 2/04551; B41J 2/04586; B41J 2/155; B41J 3/44; B41J 11/0015; B41J 29/00

(57) ABSTRACT

A printing apparatus is a printing apparatus to which a post-processing unit is mounted that reduces a height from a position of a printing medium discharged from a sheet discharge port to the sheet discharge port compared with the height before the post-processing unit is mounted. The printing apparatus includes a printing unit for printing, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode in which an ink amount in a case where printing is performed using the same image data as in the first mode is less than an ink amount in the first mode.

### BACKGROUND

### Field of the Disclosure

The present disclosure relates to a printing apparatus with a detachable post-processing unit and a printing method.

### Description of the Related Art

In a case where a printer is used in an office or the like, post processing after printing sometimes takes time and effort depending on the processing. Post-processing includes, for example, a process of sorting printed materials and a process of stapling sheets together, when meeting documents or business proposals are to be distributed into a number of copies.

A printer can improve productivity by arranging a mechanism having a post-processing function in a sheet discharge unit thereof and automatically performing post-processing.

On the other hand, if the mechanism is separated, it requires a large arrangement space. Japanese Patent Application Laid-Open No. 2022-70446 discusses adding a post-processing function without increasing a space by inserting a small post-processing mechanism into a sheet discharge unit of a printer compared with a juxtaposition type post-processing mechanism.

However, if a post-processing mechanism is inserted into a sheet discharge unit, a sheet discharge port becomes narrowed, and a paper jam (hereinbelow, also referred to as a jam) becomes more likely to occur.

### SUMMARY

According to embodiments of the present disclosure, a printing apparatus to which a post-processing unit is mounted that reduces a height from a position of a printing medium discharged from a sheet discharge port to the sheet discharge port compared with the height before the post-processing unit is mounted. The printing apparatus includes an input unit configured to input image data representing a print target image, and a printing unit configured to print, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode being different from the first mode among a plurality of print modes and in which an ink amount in a case where printing is performed using the same image data as in the first mode is less than an ink amount in a case where printing is performed using the image data in the first mode.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image processing apparatus.

FIG. 2 is a block diagram illustrating a flow of image processing.

FIG. 3 illustrates a printing apparatus in detail.

FIG. 4A illustrates a user interface (UI) for a print setting. FIG. 4B illustrates a UI for setting a post-processing function.

FIG. 5 illustrates curling on a recording medium.

FIGS. 6A and 6B schematically illustrate a curling state.

FIG. 7 illustrates a post-processing mechanism mounted in a sheet discharge unit.

FIGS. 8A and 8B illustrate an ink ejection amount and a curl amount.

FIGS. 9A and 9B illustrate a relationship between a printing time and a curl amount.

FIG. 10 is a flowchart illustrating entire processing according to a first exemplary embodiment and a second exemplary embodiment.

FIG. 11 illustrates a printing operation table.

FIGS. 12A to 12C schematically illustrate curling states in double-sided printing.

### DESCRIPTION OF THE EMBODIMENTS

Exemplary embodiments of the present disclosure will be described in detail below with reference to the attached drawings.

However, components described in the following exemplary embodiments are merely examples and are not intended to limit the scope of the present disclosure to only the components.

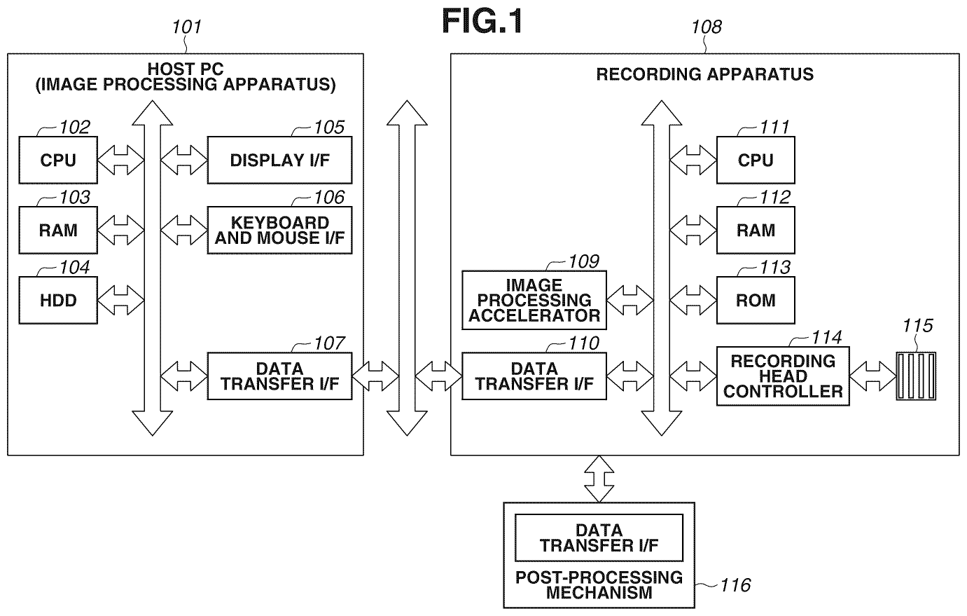

FIG. 1 is a block diagram illustrating a configuration of a printing system. An image processing apparatus 101 includes a host personal computer (PC) or a tablet PC, and a central processing unit (CPU) 102 executes various types of processing in accordance with a program stored in a hard disk drive (HDD) 104 using a random access memory (RAM) 103 as a work area. For example, the CPU 102 generates image data that can be recorded by a printing apparatus (recording apparatus 108) in accordance with a command received from a keyboard, a mouse, or a touch panel (not illustrated) via a keyboard and mouse interface (I/F) 106 and a program stored in the HDD 104. The CPU 102 then transfers the generated image data to the recording apparatus 108.

A post-processing mechanism 116 (post-processing unit) is detachable from the recording apparatus 108. Here, detachable means that it can be additionally mounted in the recording apparatus 108 that can perform printing and discharging a sheet even without the post-processing mechanism 116. At a time of mounting the post-processing mechanism 116, a sheet discharge tray and its peripheral component having been used without the post-processing mechanism 116 may be removed to provide a space for mounting the post-processing mechanism 116, and then the post-processing mechanism 116 may be mounted. In other words, the post-processing mechanism 116 may be mounted not only by being added to the recording apparatus 108 without reducing its members, but also by being replaced with a part of the members in the recording apparatus 108. In a case where the post-processing mechanism 116 is detached, the opposite is true for mounting it.

The post-processing mechanism 116 is mounted to be connected to the recording apparatus 108 and performs desired post-processing in accordance with an instruction from a control unit of the recording apparatus 108. The post-processing described here includes, for example, stapling processing for grouping a plurality of printed materials together, processing for punching holes thereon, and a function of shifting and sorting them.

The image processing apparatus 101 also performs predetermined processing on image data received from the recording apparatus 108 via a data transfer I/F 107 in accordance with a program stored in the HDD 104. A processing result and various information are displayed on a display (not illustrated) via a display I/F 105.

On the other hand, in the recording apparatus 108, a CPU 111 executes various types of processing in accordance with a program stored in a ROM 113 using a RAM 112 as a work area. The recording apparatus 108 also includes an image processing accelerator 109 for performing high-speed image processing. The image processing accelerator 109 is hardware that can execute image processing faster than the CPU 111. The image processing accelerator 109 is started when the CPU 111 writes a parameter and data to be used for image processing to a predetermined address in the RAM 112, reads the above-described parameter and data, and then executes predetermined image processing on the data. From the above description, the recording apparatus 108 can also be considered as an image processing apparatus. In this case, the image processing apparatus is included in and is a part of the recording apparatus 108. The CPU 111 and the image processing accelerator 109 also have a central role in control of the image processing apparatus in the recording apparatus 108. However, the image processing accelerator 109 is not an essential element, and the CPU 111 can execute equivalent processing.

The recording apparatus 108 is a recording apparatus using pigment ink of four colors: cyan, magenta, yellow, and black (CMYK), and an ejection amount of each nozzle of a recording head 115 as a printing unit is 4 [pl].

### <Flow of Image Processing>

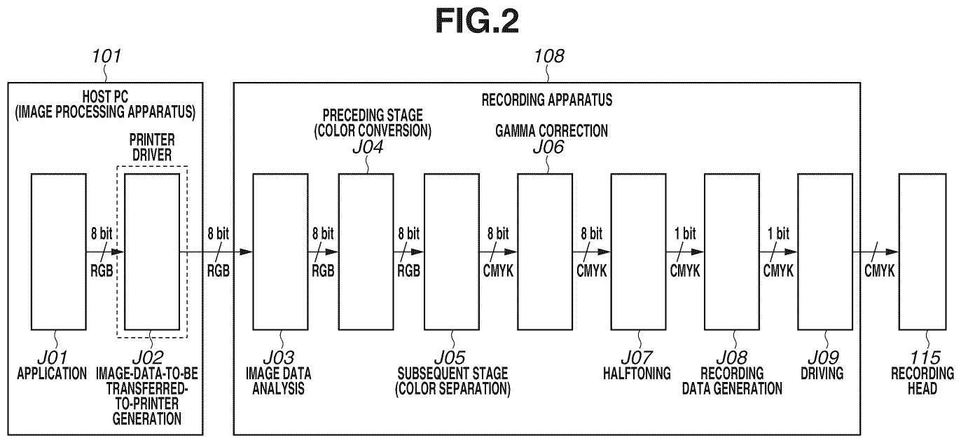

FIG. 2 is a block diagram illustrating a flow of image data conversion processing performed in a printing system according to a first exemplary embodiment. Image data conversion processing by the recording apparatus 108 will be described below.

The recording apparatus 108 according to the present exemplary embodiment performs printing using ink of four colors: cyan, magenta, yellow, and black. The recording head 115 has a nozzle array that ejects ink of these four colors. As illustrated in FIG. 2, it is assumed that each image processing in the printing system is executed by a personal computer (PC) serving as the image processing apparatus 101 and the recording apparatus 108.

Programs that operate on an operating system of the image processing apparatus 101 include an application and a printer driver. The application includes, for example, applications for creating a document or an illustration.

In application processing J01, the application executes processing for generating image data corresponding to an image to be recorded (printed) by the recording apparatus 108. The image data generated in the application processing J01 is transferred to the printer driver. The printer driver of the image processing apparatus 101 generates image data in a page description language (PDL) format as the image data. Hereinbelow, image data in the PDL format is referred to as PDL data. As an example of the PDL, Portable Document Format “PDF” by Adobe is known. The PDL is widely used as an image format that can describe not only a bitmap but also vector data such as a line and a character.

The printer driver performs image-data-to-be-transferred-to-printer generation processing J02 for generating image data to be transferred to the printer by using the image data transferred from the application. The image data to be transferred to the printer is PDL data, and the printer driver generates the image data to be transferred to the printer by adding a header portion including setting information related to printing set via a user interface (UI) of the image processing apparatus 101 to the image data to be transferred to the printer. The generated image data to be transferred to the printer is transferred from a data transfer I/F 107 of the image processing apparatus 101 to the recording apparatus 108 via a data transfer I/F 110 of the recording apparatus 108 and stored in a data buffer (not illustrated). Such image data in the PDL format is transferred from the image processing apparatus 101 to the recording apparatus 108.

The CPU 111 (image processing unit) of the recording apparatus 108 performs image data analysis processing J03.

In the image data analysis processing J03, the image data in the PDL format is read out sequentially from the data buffer. The CPU 111 interprets a drawing command included in the PDL data and renders the PDL data into raster image data in a format similar to a bitmap. The rendered raster image data is then stored in the data buffer. The analyzed and rendered raster image data is further subjected to image processing by the CPU 111.

The CPU 111 performs color conversion processing J04 (preceding stage) for matching colors between models, color separation processing J05, gamma correction processing J06, halftoning processing J07 which is binary quantization, and recording data generation processing J08. Hereinunder, each processing will be briefly described.

In the color separation processing J05, color separation processing is performed in which 8-bit data red (R), green (G), and blue (B) acquired in the preceding stage processing J04 is converted into color separation data (here, 8-bit data C, M, Y, and K) corresponding to a combination of inks reproducing the color represented by the RGB data. Specifically, a conversion table (e.g., three-dimensional look-up table (LUT)) is used in which RGB data and CMYK data corresponding to ink are in one-to-one correspondence. The RGB data is converted into the CMYK data by referring to the conversion table. For example, in the three-dimensional LUT, R, G, and B values, each of which is represented by 8 bits (0 to 255), and CMYK values, each of which is represented by 8 bits (0 to 255), are associated with each other in advance. Conversion is then performed from (R, G, B)=(0 to 255, 0 to 255, 0 to 255) to (C, M, Y, K)=(0 to 255, 0 to 255, 0 to 255, 0 to 255).

For example, in a case of (R, G, B)=(0, 0, 0), it is converted into (C, M, Y, K) =(0, 0, 0, 255). In a case of (R, G, B)=(255, 255, 255), it is converted into (C, M, Y, K)=(0, 0, 0, 0). In a case of (R, G, B)=(0, 128, 0), it is converted into (C, M, Y, K)=(128, 0, 128, 0).

According to the present exemplary embodiment, at least two types of such conversion tables (three-dimensional LUTs) as described above are provided. The conversion table to be used is then switched based on a predetermined condition. Details are described below.

In the gamma correction processing J06, gradation value conversion is performed on each ink color data of the color separation data acquired in the color separation processing J05. Specifically, conversion is performed such that the color separation data linearly corresponds to a gradation characteristic of the recording apparatus 108 by using a one-dimensional LUT corresponding to a gradation characteristic of each color ink of the recording apparatus 108.

In the halftoning processing J07, quantization processing is performed to convert each of the 8-bit color separation data C, M, Y, and K into 1-bit data. According to the present exemplary embodiment, processing for converting 256-gradation 8-bit data into 2-gradation 1-bit data is performed using a binary dither method. In the recording data generation processing J08, recording data is generated by adding recording control information to recording image data including 1-bit dot data. The generated recording data is stored in a recording buffer (not illustrated). The binary recording data stored in the recording buffer is sequentially read out by the CPU 111 and input to a recording head controller 114, and driving processing J09 is performed. In the driving processing J09, the 1-bit data of each color input to the recording head controller 114 is converted into a driving pulse for the recording head 115, and the ink is ejected at a predetermined timing.

### <Details of Printing Apparatus>

The printing apparatus according to the present exemplary embodiment will be described more specifically below.

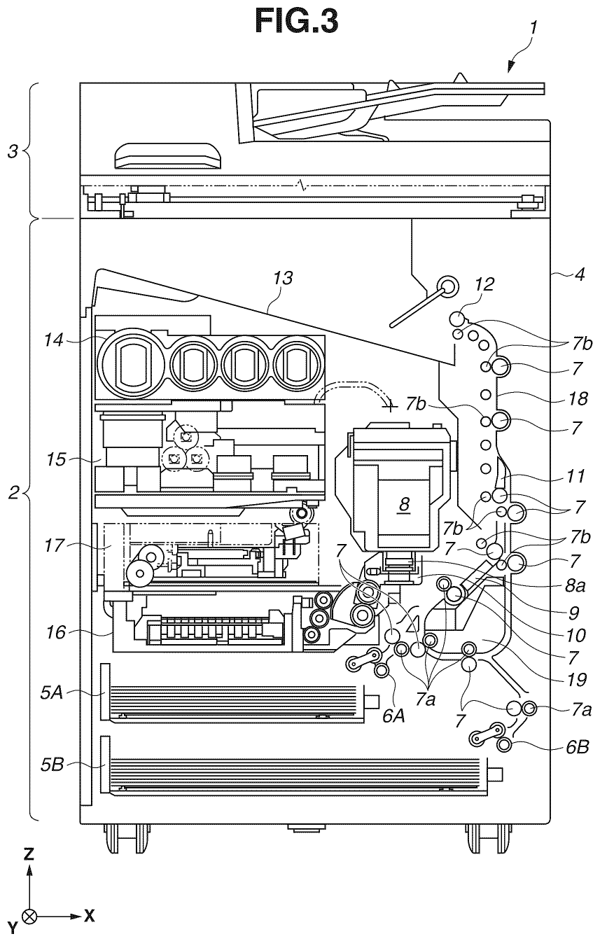

A recording apparatus 1 in FIG. 3, which is an example of the recording apparatus 108, is a multi-function peripheral that includes a printing unit 2 and a scanner unit 3. The recording apparatus 1 can execute various types of processing related to a recording operation and a reading operation using the printing unit 2 and the scanner unit 3 individually or in conjunction with each other. The scanner unit 3 includes an automatic document feeder (ADF) and a flat-bed scanner (FBS). Thus, the scanner unit 3 can read a document automatically fed by the ADF and can also read (scan) a document on a document platen of the FBS placed by a user. According to the present exemplary embodiment, the recording apparatus 1 is the multi-function peripheral that includes both the printing unit 2 and the scanner unit 3, but may not include the scanner unit 3.

FIG. 3 illustrates the recording apparatus 1 in a standby state in which neither the recording operation nor the reading operation is not being performed.

In the printing unit 2, a first cassette 5A and a second cassette 5B for storing recording media (cut sheets) S are detachably installed at a bottom in a vertical direction of a housing 4. The first cassette 5A stores relatively small recording media up to A4 size, and the second cassette 5B stores relatively large recording media up to A3 size in a flat stack. A first feeding unit 6A that separates and feeds the stored recording media S one by one is provided near the first cassette 5A. Similarly, a second feeding unit 6B is provided near the second cassette 5B.

When the recording operation is performed, the recording medium S is selectively fed from either one of the cassettes. Conveyance rollers 7, a discharge roller 12, pinch rollers 7a, driven rollers 7b, a guide 18, an inner guide 19, and a flapper 11 are a conveyance mechanism for guiding the recording medium S in a predetermined direction. The conveyance rollers 7 are drive rollers that are arranged on upstream and downstream sides of a recording head 8 (platen 9) and driven by a conveyance motor. The pinch rollers 7a are driven rollers that rotate together with the conveyance rollers 7 while nipping the recording medium S. The discharge roller 12 is a drive roller that is arranged on the downstream side of the conveyance rollers 7 and driven by a discharge motor. The driven rollers 7b pinch and convey the recording medium S together with the conveyance rollers 7 and the discharge roller 12 arranged on the downstream side of the recording head 8 (platen 9). The guide 18 is provided on a conveyance path of the recording medium S and guides the recording medium S in the predetermined direction.

The inner guide 19 is a member extending in a y direction, has a curved side surface, and guides the recording medium S along the curved side surface. The flapper 11 is a member for switching a direction in which the recording medium S is conveyed in a double-sided recording operation.

A sheet discharge tray 13 included in a sheet discharge unit is a tray on which the recording medium S discharged by the discharge roller 12 after the recording operation is completed is stacked.

The recording head 8 according to the present exemplary embodiment is a full-line type color inkjet recording head including a plurality of ejection ports that eject ink in accordance with recording data. The plurality of ejection ports are arranged along the Y direction illustrated in FIG. 3 for a length that corresponds to a width of the recording medium S. In a case where the recording head 8 is in a standby position, an ejection port surface 8a of the recording head 8 faces vertically downward and is capped by a cap unit 10 as illustrated in FIG. 3. When the recording operation is performed, an orientation of the recording head 8 is changed so that the ejection port surface 8a faces the platen 9 by the recording head controller 114.

The platen 9 formed of a flat plate extending in the Y direction supports, from a back surface, the recording medium S on which the recording operation is performed by the recording head 8.

An ink tank unit 14 stores each of the four colors of ink to be supplied to the recording head 8. An ink supply unit 15 is disposed in the middle of a flow path connecting the ink tank unit 14 and the recording head 8 to adjust a pressure and a flow rate of the ink in the recording head 8 within appropriate ranges. According to the present exemplary embodiment, a circulation type ink supply system is adopted, and the ink supply unit 15 adjusts the pressure of the ink supplied to the recording head 8 and the flow rate of the ink collected from the recording head 8 within the appropriate ranges. A maintenance unit 16 includes the cap unit 10 and a wiping unit 17 and operates these units at a predetermined timing to perform a maintenance operation on the recording head 8.

### <Post-Processing Mechanism>

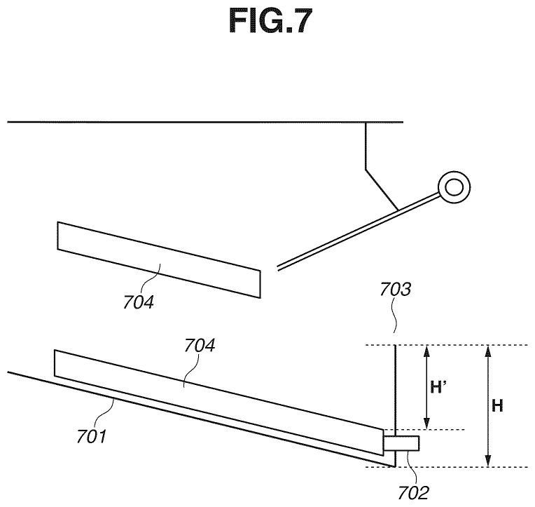

The post-processing mechanism can be mounted in the sheet discharge unit of the printing apparatus. The printing apparatus can thereby use a post-processing function without increasing a footprint. FIG. 7 illustrates an excerpt of the sheet discharge unit in FIG. 3. FIG. 7 also illustrates a post-processing mechanism 704 mounted in the sheet discharge unit. The post-processing mechanism 704 is mounted along a sheet discharge tray 701, and a sensor 702 can determine whether the post-processing mechanism 704 is mounted.

Here, the post-processing mechanism will be described. The post-processing mechanism has a shifting and sorting function, a punching function of performing punching processing, and a stapling function. Each function will be briefly described. The shifting and sorting function is a mechanism that shifts a sheet bundle according to the number of copies so that they can be separated after finishing. After printing, moisture is applied to a printed surface side of the medium, which breaks hydrogen bonds in the medium and causes it to swell, and thus the medium warps with the printed surface side convex, details of which will be described below. A succeeding medium is discharged onto a preceding medium, which is in the warped state on the sheet discharge tray after being discharged.

In a case where sorting function is not performed, right and left sheet discharge positions are aligned, so that the media do not collide with each other, and a paper jam does not occur. However, if shifting and sorting function is performed, the succeeding medium enters toward the preceding medium, which is warped convexly downward after being discharged, at a shifted position, so that the media collide with each other. The collision thus makes a jam more likely to occur.

The stapling function is a function of automatically stapling sheets. The stapling function can significantly reduce a time required to create a stapled material, such as a meeting material or a proposal material. In a case where the stapling function is applied, a shift of a bundle is fixed as it is, which is not visually pleasing, so that higher alignment is required. In addition, the media need to be inserted into a narrow opening in a stapler, and a jam is more likely to occur even with a small amount of curling.

The punching function is a function of punching holes in a printed sheet. Generally, the punched holes are used to bundle the printed sheets together with a ring or the like for filing. At this time, if a shifted amount is large, alignment after filing will be poor, so that high accuracy of alignment is required. In addition, the media is to be inserted into a narrow opening of a puncher, and thus a jam is more likely to occur even with a small amount of curling.

### <Print Settings>

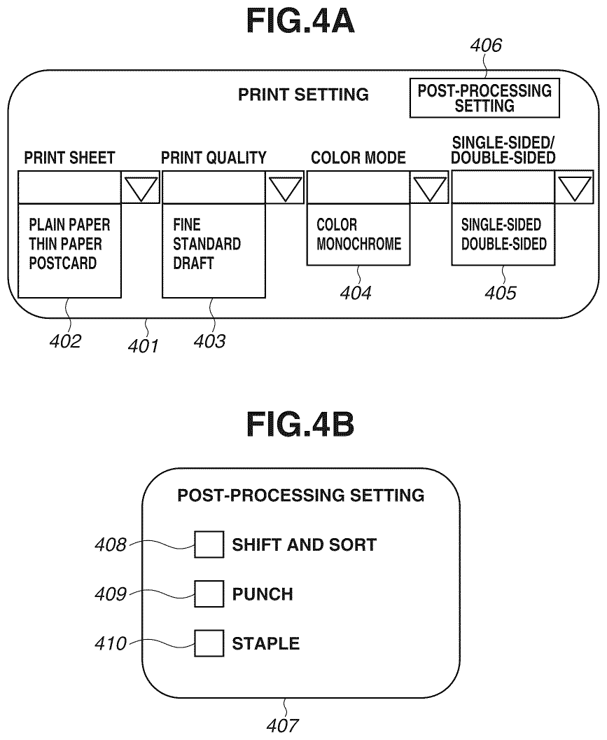

As illustrated in FIG. 4A, a driver UI 401 for issuing a print instruction to the printer allows a user to select items, such as, a print sheet type selection 402, a print quality setting 403, a color mode 404, and a single-sided/double-sided setting 405. The print sheet refers to, for example, plain paper, thin paper, and a postcard. The print quality refers to print settings with different print quality, such as fine, standard, and draft, and speed. The color mode refers to color or monochrome print setting, and single-sided printing or double-sided printing can be specified using the single-sided/double-sided setting.

### <Post-Processing Settings>

As illustrated in FIG. 4A, the driver UI 401 serving as a UI image for issuing a print instruction to the printer includes a post-processing setting button 406. This setting can be selected only if the sensor 702 determines that the post-processing mechanism is mounted. Specifically, if it is not determined that the post-processing mechanism is mounted, the post-processing setting button 406 is not displayed and selection cannot be performed. Alternatively, the post-processing setting button 406 may be grayed out so as not to be selected.

If the post-processing setting button 406 is selected, a post-processing setting UI 407 as illustrated in FIG. 4B is displayed. The displayed UI includes a shifting and sorting function check box 408, a punching function check box 409, and a stapling function check box 410. A user selects desired post-processing, and the post-processing mechanism executes the desired processing according to the instruction. An example in which the setting processing according to FIGS. 4A and 4B is performed by the image processing apparatus 101 is described above, but the setting processing may be performed by the recording apparatus 108. In this case, the setting is performed via a panel input unit or the like connected to the recording apparatus 108.

### <Principle of Curling>

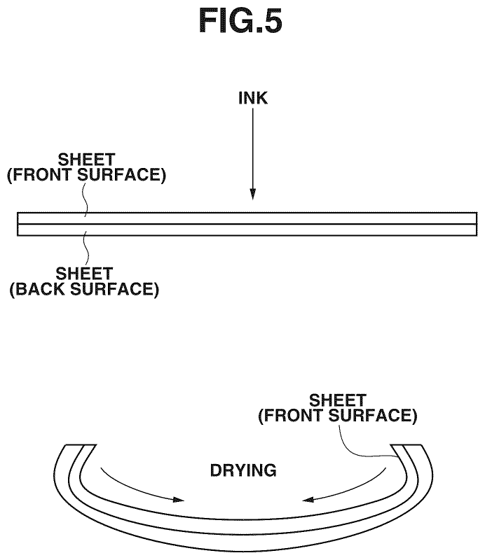

FIG. 5 illustrates curling on a recording medium in single-sided printing. An inkjet printer often uses water-based ink. Thus, if an image is printed only on one side of a sheet, moisture (solvent component of ink) penetrates fibers of the sheet, and a front surface side of the sheet swells first. As a result, the sheet curls such that the front surface side is raised. Thereafter, the moisture penetrated into the fibers of the sheet evaporates, and the front surface side shrinks more than before printing. As a result, the sheet curls such that a printed surface is inside as illustrated in FIG. 5.

The mechanism of curling will now be described in more detail. In a case where moisture is added to a sheet, the hydrogen bonds formed between the cellulose fibers of the sheet are once broken. In other words, the addition of moisture causes swelling of the cellulose and also a chemical phenomenon. At this time, the ink does not penetrate uniformly in a depth direction of the sheet, and an ink amount becomes less in a deeper portion. An area where the ink is applied, that is, the fiber that comes into contact with water swells and causes the sheet to warp and curl in the direction opposite to the surface to which the moisture is applied, i.e., a minus curl occurs.

However, the moisture once absorbed into the cellulose gradually evaporates, and as the cellulose begins to shrink, the hydrogen bonds that were once broken are recombined. At that time, the hydrogen bonds are not recombined at positions where they were broken, but rather recombined at different positions, so that the sheet gradually warps and curls in the direction of the surface to which the moisture is applied.

In other words, a plus curl occurs.

A state where the back surface of the sheet warps toward the front surface side to make concave on the front surface side is referred to as a plus curl, and a state where the front surface warps toward the back surface side to make convex on the front surface side is referred to as a minus curl. In particular, a plus curl becomes a problem in a case where inkjet recording is performed on plain paper. If a plus curl occurs, the discharged recording medium may be misaligned or paper jamming may occur.

### <Paper Curling and Jamming>

A phenomenon in which paper jamming occurs in a process of discharging a curled recording medium will now be described in detail.

In recording using the inkjet method, a curl amount that occurs in the recording medium varies depending on a recording duty of an image or an ink ejection amount (application amount). Particularly, in a case where the ink application amount is large, curling of the recording medium that occurs after recording tends to increase. In addition, curls increase at a low temperature and low humidity.

Thus, if the recording medium continues to be conveyed with a large curl and is discharged to the sheet discharge tray of the recording apparatus, the curl of the recording medium increases because the recording medium is changed from a state where the curl is regulated in the conveyance path to a released state. Alternatively, if the recording medium is discharged to the sheet discharge tray in a state where the curl thereof is not stable, it may be greatly deformed thereafter.

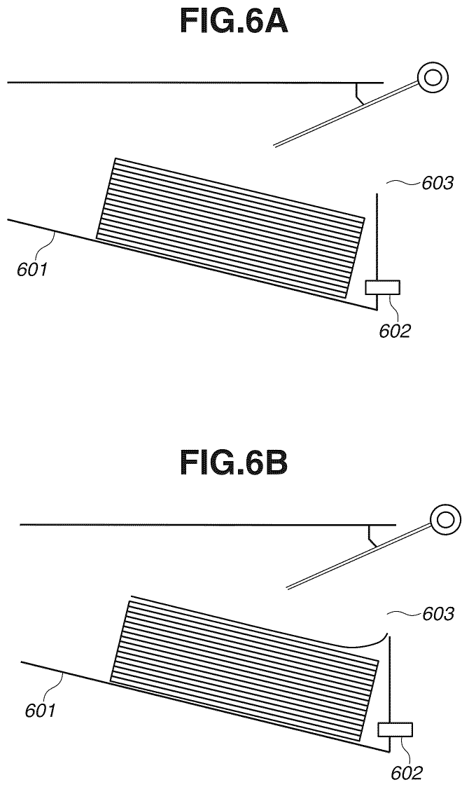

FIG. 6A illustrates a state of recording media discharged to the sheet discharge tray. FIG. 6B schematically illustrates a state where a succeeding recording medium is discharged onto a recording medium that was previously placed on the sheet discharge tray in a curled and raised state.

In FIG. 6A, even if the recording medium is placed on the sheet discharge tray, the succeeding recording medium that is discharged from a sheet discharge port 603 does not come into contact with the placed recording medium.

As is clear from FIG. 6B, the succeeding recording medium discharged from the sheet discharge port 603 enters and comes into contact with the preceding recording medium that is placed on the sheet discharge tray in the curled and raised state. As a result, the succeeding recording medium is pushed upward, deformed, and thus causes a paper jam.

If the curl of the preceding recording medium decreases over time and settles to a height lower than a position where the recording medium is discharged, the succeeding recording medium is discharged without coming into contact with the preceding recording medium, and thereby a paper jam does not occur.

### <Post-Processing Mechanism and Paper Jam>

Here, a paper jam in a case where the post-processing mechanism is provided will be described with reference to FIG. 7. A height from a sheet discharge port 703 to the sheet discharge tray 701 before the post-processing mechanism 704 is mounted is denoted by H. Further, a height from the sheet discharge port 703 to a sheet discharge position of the post-processing mechanism 704 after the post-processing mechanism 704 is mounted is denoted by H′. As can be seen from FIG. 7, if the post-processing mechanism 704 is mounted, a stacking height of the sheet discharge unit is lowered, and a sheet discharge space is narrowed. On the other hand, as described above, curling occurs due to printing. In a case where the post-processing mechanism 704 is mounted, the stacking height is narrowed, so that it is required to reduce a curl amount more than that in a case where the post-processing mechanism 704 is not mounted to make a paper jam less likely to occur.

### <Ejection Amount and Curl>

If a moisture amount applied to per unit area of a sheet increases, a penetration depth of the moisture into the sheet increases accordingly. Hydrogen bonds are broken in the depth direction of the sheet, and the amount of fibers participating in the curl increases, so that a degree of the curl increases with an ejection amount. A relationship between an ink ejection amount and a curl amount will be described in detail below.

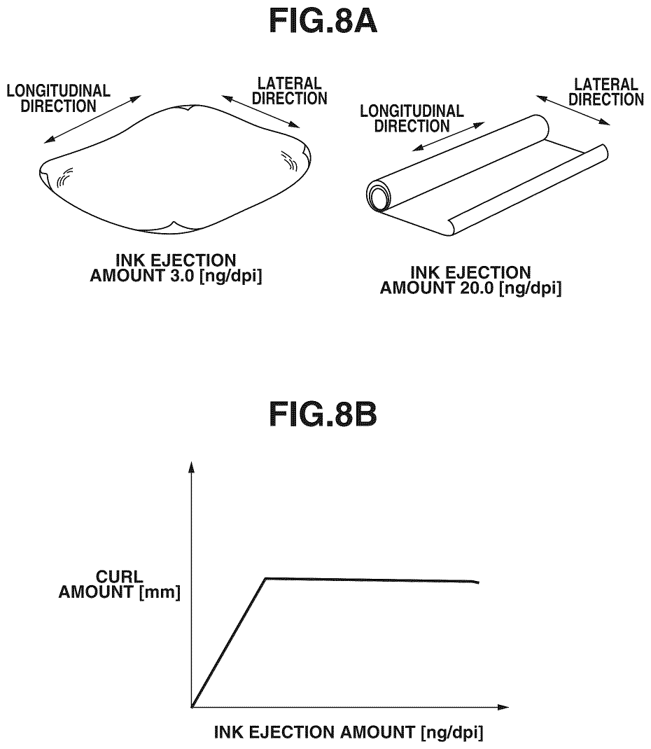

FIG. 8A illustrates directions in which a sheet tends to curl. As described above, paper has a fiber direction (paper grain), and it is assumed that a sheet used in the present exemplary embodiment has a flow of fibers along a longitudinal direction. In this case, the sheet tends to curl in a lateral direction. Particularly, in a case where an ink ejection amount is small (3.0 ng/dpi), curling occurs almost equally in the longitudinal direction and the lateral direction, but in a case where the ink ejection amount is large (20.0 ng/dpi), curling more easily occurs in the lateral direction than in the longitudinal direction.

FIG. 8B illustrates a result of a relationship between an ink ejection amount and a generation amount of an initial curl (curl), which was examined by a following method. A solid image was printed on plain paper with a constant amount of ink using an inkjet printer, and a curl amount was measured from immediately after the paper was ejected from the printer. The curl amount was measured in such a manner that the time when printing was finished was set as time 0, the paper was placed with its printed surface down after being discharged, and a maximum height (H) of the upward curl (back curl) along the edge of the paper was measured at four points, and an average value was calculated and evaluated.

As is clear from FIG. 8B, in an area where the ink ejection amount is small, the curl amount increases as the ink ejection amount increases.

The reason for this behavior is that the occurrence of curling is determined by a difference in stretch (pulling) between the front and back sides of the paper, and while the ink ejection amount is small, the paper stretches greatly and curls greatly.

It can be thought that if the ink ejection amount exceeds a certain amount, the moisture amount that penetrates into the paper increases, so that the difference in stretch (pulling) between the front and back sides of the paper decreases, and the curl does not change.

### <Printing Speed and Curl>

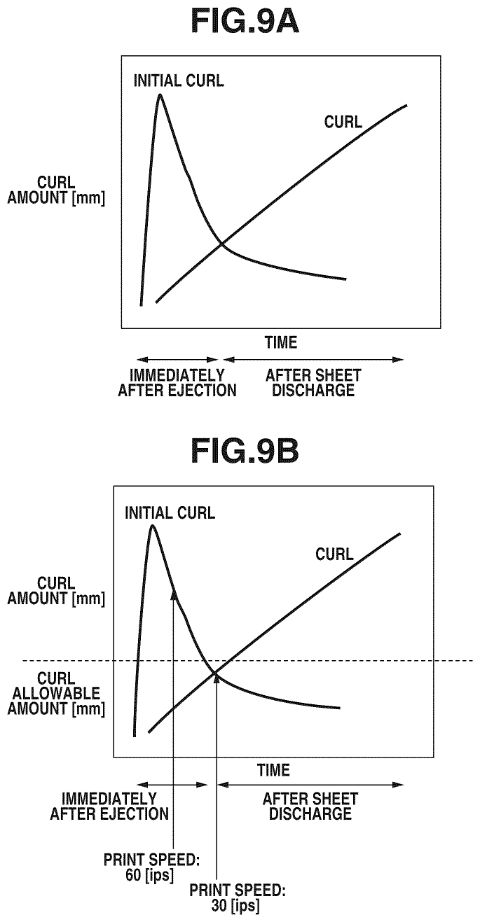

FIG. 9A illustrates a relationship between an elapsed time after printing and a curl amount. Horizontal and vertical axes in FIG. 9A schematically indicate the elapsed time since the ink was applied and the curl amount, respectively. The curl amount was measured using a similar method as described above, by printing a solid image on plain paper with a constant amount of ink and measuring a change amount immediately after the paper was discharged from the printer.

As illustrated in FIG. 9A, an amount of the initial curl is large immediately after the ink was applied, and the curl amount decreases over time. On the other hand, it can be seen that a final curl amount tends to increase over time. The reason for this curling behavior is that, immediately after printing, the front surface side of the paper curls to be raised due to swelling. Then, the moisture that penetrates into the paper evaporates and causes the front surface side to shrink more than before printing, so that the paper curls with the printed surface inside.

In response to this behavior, a paper jam caused by contacting with the succeeding recording medium can be suppressed by delaying discharge of the succeeding recording medium until the maximum value of the initial curl amount of the preceding recording medium becomes lower than a position corresponding to a height of the sheet discharge port of the sheet discharge tray in the recording apparatus.

FIG. 9B illustrates an amount of curling that is generated in a case where printing is performed at printing speeds corresponding to a standard mode and a draft mode according to the present exemplary embodiment in addition to the relationship in FIG. 9A. The printing speed is slower in the standard mode than in the draft mode, and in the case of the standard mode, it can be seen that the initial curl amount exceeds a curl allowable amount.

For example, if printing is continued in the standard mode without changing the printing speed, the succeeding recording medium may come into contact with the preceding recording medium and cause a paper jam depending on an ink ejection amount to a print sample.

The curl of the preceding recording medium decreases over time. Then, if the curl settles to a height lower than the position where the recording medium is discharged, the succeeding recording medium is discharged without coming into contact with the preceding recording medium, and thus a paper jam does not occur. In other words, if the printing speed is lowered, a time from a start of printing to paper discharge can be made longer, and the curl amount after paper discharge can be reduced.

It can thus be understood that it is desirable to set the printing speed based on the above-described relationship between the printing speed and the curl amount.

### <Printing Operation When Post-Processing Mechanism is Mounted>

Based on the above description, curl reduction according to the present exemplary embodiment will be described.

As described above, mounting of the post-processing mechanism narrows the sheet discharge port and makes a paper jam more likely to occur. Thus, it is necessary to reduce the curl amount after printing after the post-processing mechanism is mounted compared with that before the post-processing mechanism is mounted.

As a method for reducing the curl amount, there is a method for reducing the printing speed as described above. For example, it is possible to adjust a wait time during printing, a carriage scan speed, or increasing the number of printing paths.

Here, a printing time in a case where printing is performed without mounting the post-processing mechanism is considered. It is assumed that if the print quality setting 403 is set to the standard mode (first mode) in a print setting via a print setting UI as illustrated in FIG. 4A, printing is performed in a printing time t (seconds). It is also assumed that, in a case of a mode different from the standard mode that uses a relatively small amount of ink if the same print target image as in the standard mode is printed, for example, the draft mode (second mode), printing is performed in a printing time s (seconds).

Next, a printing time in a case where printing is performed after the post-processing mechanism is mounted will be considered. It is assumed that if the print quality setting 403 is set to the standard mode in the print setting via the print setting UI, printing is performed in a printing time t′ (seconds).

Then, a relationship among each printing time is t′>t>s (seconds). In other words, since it is necessary to reduce the curl amount after printing after the post-processing mechanism is mounted compared with that before the post-processing mechanism is mounted, the printing time t′ is the longest.

By the way, as described above, if the ink amount used in printing is small, the curl amount is also small, and a paper jam is less likely to occur. Modes in which the amount of ink used is smaller than that in the standard mode are, for example, the draft mode and an economical mode, which are modes for checking a layout and for performing printing with less ink to save ink consumption. As described above, a monochrome mode is also a mode that uses a small amount of ink.

In such modes that use a small amount of ink, the curl amount is small, and thus there is no need to reduce the printing speed even if the post-processing mechanism is mounted. Alternatively, a degree to which the printing speed is reduced (a degree of speed reduction) may be controlled to be small. In other words, the degree to which the printing speed is reduced before and after the post-processing mechanism is mounted is changed depending on a print mode, and it is thus possible to suppress a decrease in printing productivity.

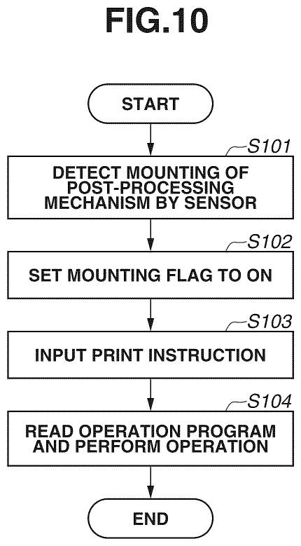

Based on the above description, operations of the printing apparatus (the recording apparatus 108) in a case where the post-processing mechanism is mounted will be described with reference to FIG. 10. Processing in each step is executed or controlled by the CPU 111. Each process (step) in the flowchart is indicated by a reference numeral beginning with S.

In step S101, the sensor detects mounting of the post-processing mechanism. As illustrated in FIG. 7, the sensor 702 detects whether the post-processing mechanism is mounted.

In step S102, upon receiving a signal from the sensor 702 detecting that the post-processing mechanism has been mounted, the CPU 111 sets a post-processing mounting flag, which is stored in the RAM 112 and indicates whether the post-processing mechanism is mounted, to ON.

In step S103, a user inputs a print instruction from the print setting UI 401.

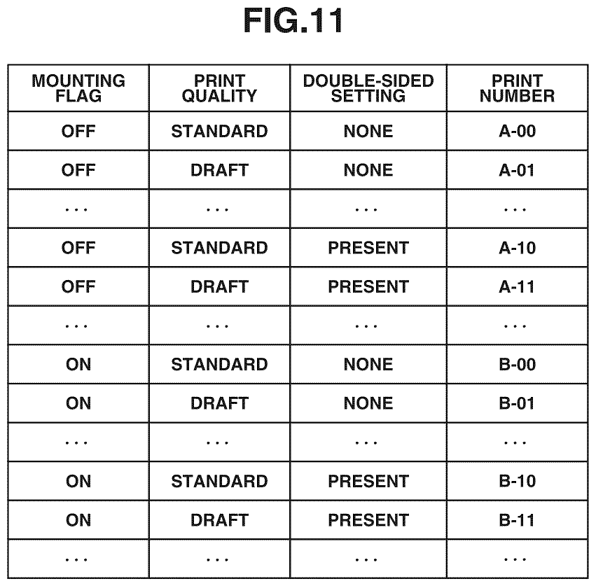

In step S104, according to the print instruction input in step S103, the CPU 111 refers to a printing operation table in the ROM 113, reads out a corresponding printing operation program, loads the program into the RAM 112 to execute a printing operation specified in the printing operation program. For example, the printing operation table is a table as illustrated in FIG. 11. In the table, a printing operation number is set for each combination of printing condition settings, such as whether the post-processing mechanism is mounted and a print mode. The CPU 111 reads out a desired printing operation program based on the printing operation number. Although an example using the table is described above, the table may be realized by another method as long as a correspondence relation between each combination of printing condition settings and the printing operation is linked to each other.

The correspondence relation between the combination of printing condition settings and the printing operation will be described using an example. In a case where the post-processing mounting flag is OFF and the standard mode is selected, a print number A-00 is associated, and in a case where the draft mode is selected, a print number A-01 is associated. In a case where the post-processing mounting flag is ON and the standard mode is selected, a print number B-00 is associated, and in a case where the draft mode is selected, a print number B-01 is associated.

Here, an operation program is set such that the print number A-00 is for printing with a printing time t (seconds), the print number A-01 is for printing with a printing time s (seconds), the print number B-00 is for printing with a printing time t′ (seconds), and the print number B-01 is for printing with a printing time s′ (seconds). At this time, there is a relationship of t′ (seconds)>t (seconds)>s′ (seconds)=s (seconds), and the time t′ (seconds) is the longest time to be used for the printing operation. The relationship may also be s′ (seconds)>s (seconds), as long as an increase rate of s′ (seconds) relative to s (seconds) is smaller than an increase rate of t′ (seconds) relative to t (seconds). In other words, the CPU 111, which is a control unit, controls printing such that the degree of speed reduction in printing after the post-processing unit is mounted compared with before the post-processing unit is mounted is smaller in the draft mode than in the standard mode.

With such a relationship, even if the post-processing mechanism is mounted, the printing time is not increased or a degree of increase in the print time can be suppressed in a print mode in which a jam prevention measure is not required. It is thus possible to suppress a decrease in printing productivity.

According to the first exemplary embodiment, a print mode using a small amount of ink is described as an example of a print mode in which a curl amount is small. According to a second exemplary embodiment, a case in which double-sided printing is used will be described as a print mode in which a curl amount is small. Below, a relationship between double-sided printing and curling will be described, and then operations according to the second exemplary embodiment will be described.

### <Double-Sided Printing and Curling>

In the above, it is described that if an image is printed on a sheet, which is a printing medium, moisture (solvent component of ink) penetrates the fibers of the sheet and evaporates, and the recording medium curls. Curling occurs not only in single-sided printing but also in double-sided printing. However, in the case of double-sided printing, a difference between ink amounts applied to the front surface and the back surface affects a degree of curling. If the difference is large, swelling and shrinking rates differ, and the sheet curls.

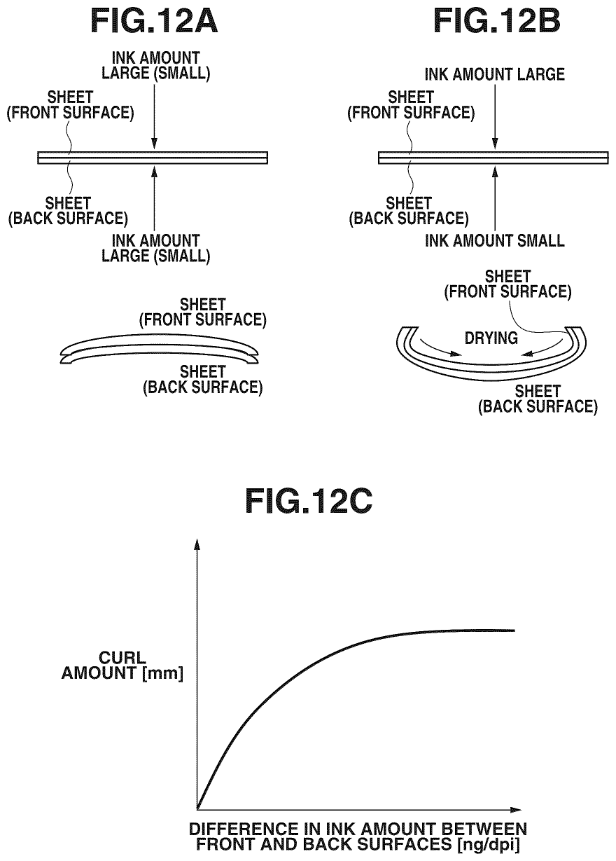

FIGS. 12A to 12C illustrate curling of a recording medium in double-sided printing. FIG. 12A illustrates curling in a case where the difference in ink amount between the front and back surfaces is small. FIG. 12B illustrates a curl in a case where the difference in ink amount between the front and back surfaces is large. FIG. 12C schematically illustrates a relationship between the difference in ink amount between the front and back surfaces and a curl amount.

As can be seen from FIG. 12C, if the difference in ink amount between the front and back surfaces becomes large, curling occurs. In other words, if the difference in ink amount between the front and back surfaces is small, curling is less likely to occur. In single-sided printing, the ink amount is present only one side, but in double-sided printing, the ink amount is present on both sides, so that the difference in ink amount between the front and back surfaces is small in double-sided printing compared with single-sided printing. Thus, if double-sided printing is set, the curl amount is less than in single-sided printing, so that paper-jamming is less likely to occur, and there is no need to reduce the printing speed as compared with the case of single-sided printing.

### <Printing Operation When Post-Processing Mechanism is Mounted>

Printing operations according to the present exemplary embodiment will now be described. Differences from the first exemplary embodiment will mainly be described.

The correspondence relation between the combination of printing condition settings including a printing condition setting for double-sided printing and the printing operation will be described with reference to an example in FIG. 11. In a case where the post-processing mounting flag is OFF and the standard mode is selected, the print number A-00 is associated, and in a case where a double-sided printing setting (hereinbelow, also referred to as a double-sided setting) is selected even in the standard mode, a print number A-10 is associated. In a case where the post-processing mounting flag is ON and the standard mode is selected, the print number B-00 is associated, and in a case where the double-sided setting is selected even in the standard mode, a print number B-10 is associated.

Here, an operation program is set such that the print number A-00 is for printing with a printing time t (seconds), the print number A-10 is for printing with a printing time s (seconds), the print number B-00 is for printing with a printing time t′ (seconds), and the print number B-10 is for printing with a printing time s′ (seconds). At this time, there is a relationship of t′ (seconds)>t (seconds)>s′ (seconds)=s (seconds), and the time t′ (seconds) is the longest time r to be used for the printing operation. The relationship may also be s′ (seconds)>s (seconds), as long as the increase rate of s′ (seconds) relative to s (seconds) is smaller than the increase rate of t′ (seconds) relative to t (seconds).

With such a relationship, even if the post-processing mechanism is mounted, the printing time is not increased or a degree of increase in the print time can be suppressed in a print mode in which a jam prevention measure is not required. It is therefore possible to suppress a decrease in printing productivity.

According to the present exemplary embodiment, double-sided printing is described as a print mode in which a curl amount is small. However, a printing time may be set by combining double-sided printing and a mode in which an ejection amount is also small according to the first exemplary embodiment. The standard mode and the draft mode are described as examples, but a high quality or fine mode (the ejection amount is large) and the standard mode (the ejection amount is small) may also be used as long as the ink ejection amounts are different. Furthermore, an operation program with a short printing time may be used in a case where under color removal (UCR) processing is ON in terms of reducing the ink ejection amount.

According to the above-described exemplary embodiments, a serial head is used as an example, but a line head may also be used. In the case of a line head, an ink amount applied to a sheet surface at one time is large, so that a curl amount is also expected to be large, and the present exemplary embodiments can provide a high effect.

The present exemplary embodiments can also be realized by processing of supplying a program for implementing one or more functions of the above-described exemplary embodiments to a system or an apparatus via a network or a storage medium and having one or more processors in a computer of the system or the apparatus read and execute the program. The present exemplary embodiments can also be realized by a circuit (e.g., an application specific integrated circuit (ASIC)) that realizes one or more functions.

According to the present description, it is possible to provide an appropriate printing operation while reducing paper jamming before and after a post-processing mechanism is mounted.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-013721, filed Jan. 31, 2024, which is hereby incorporated by reference herein in its entirety.

What is claimed is:

1. A printing apparatus to which a post-processing unit is mounted that reduces a height from a position of a printing medium discharged from a sheet discharge port to the sheet discharge port compared with the height before the post-processing unit is mounted, the printing apparatus comprising:
an input unit configured to input image data representing an image serving as a print target; and
a printing unit configured to print, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode being different from the first mode among a plurality of print modes and in which an ink amount in a case where printing is performed using same image data as in the first mode is less than an ink amount in a case where printing is performed using the image data in the first mode.

2. The printing apparatus according to claim 1, wherein the printing unit makes a printing speed in the second mode after the post-processing unit is mounted lower than a printing speed in the second mode before the post-processing unit is mounted.

3. The printing apparatus according to claim 1, wherein, in the second mode, the printing unit reduces the degree of reduction by adjusting a wait time during printing, adjusting a carriage scan speed, or increasing a number of printing paths.

4. The printing apparatus according to claim 1, wherein the printing unit sets a printing speed in the first mode after the post-processing unit is mounted to be the slowest among the plurality of print modes.

5. The printing apparatus according to claim 1, wherein the first mode is a print mode in which a print quality is set to standard, and the second mode is a print mode in which the print quality is set to draft.

6. The printing apparatus according to claim 1, wherein the first mode is a print mode in which a print quality is set to high quality, and the second mode is a print mode in which the print quality is set to standard.

7. The printing apparatus according to claim 1, wherein the first mode is a print mode in which a print quality is set to standard, and the second mode is a print mode in which the print quality is set to economical.

8. The printing apparatus according to claim 1, wherein the first mode is a print mode in which double-sided printing is set to OFF, and the second mode is a print mode in which double-sided printing is set to ON.

9. The printing apparatus according to claim 1, wherein the first mode is a print mode for color printing, and the second mode is a print mode for monochrome printing.

10. The printing apparatus according to claim 1, wherein the first mode is a print mode in which under color removal (UCR) processing is set to OFF, and the second mode is a print mode in which UCR processing is set to ON.

11. The printing apparatus according to claim 1, further comprising a sensor configured to detect whether the post-processing unit is mounted.

12. The printing apparatus according to claim 1, further comprising a display unit configured to display a user interface (UI) image to which a setting for a print mode is input.

13. The printing apparatus according to claim 1, further comprising the post-processing unit.

14. The printing apparatus according to claim 1, wherein the post-processing unit is mounted in the printing apparatus by being replaced with a part of members of the printing apparatus.

15. The printing apparatus according to claim 1, wherein the printing apparatus discharges a printing medium on which the print target image is printed even without the post-processing unit.

16. The printing apparatus according to claim 1, further comprising a line head as the printing unit.

17. The printing apparatus according to claim 1, wherein post-processing by the post-processing unit includes stapling processing, punching processing for punching a hole, and shifting and sorting.

18. A non-transitory computer-readable storage medium storing instructions that, when executed by a computer, cause the computer to perform a method in a printing apparatus to which a post-processing unit is mounted that reduces a height from a position of a printing medium discharged from a sheet discharge port to the sheet discharge port compared with the height before the post-processing unit is mounted, the method comprising:
inputting image data representing a print target image; and
printing, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode being different from the first mode among a plurality of print modes and in which an ink amount in a case where printing is performed using same image data as in the first mode is less than an ink amount in a case where printing is performed using the image data in the first mode.

19. A method for performing printing in a printing apparatus to which a post-processing unit is mounted that reduces a height from a position of a printing medium discharged from a sheet discharge port to the sheet discharge port compared with the height before the post-processing unit is mounted, the method comprising:
inputting image data representing a print target image; and
printing, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode being different from the first mode among a plurality of print modes and in which an ink amount in a case where printing is performed using same image data as in the first mode is less than an ink amount in a case where printing is performed using the image data in the first mode.

20. A printing apparatus to which a post-processing unit is mounted that reduces a height from a position of a printing medium discharged from a sheet discharge port to the sheet discharge port compared with the height before the post-processing unit is mounted, the printing apparatus comprising:
an input unit configured to input image data representing a print target image; and
a printing unit configured to print, in a case where the post-processing unit is mounted, the image such that a degree of reduction in a printing speed after the post-processing unit is mounted compared with a printing speed before the post-processing unit is mounted is smaller in a second mode than a degree of reduction in a first mode, the second mode being different from the first mode among a plurality of print modes and in which a curl amount in a case where printing is performed using same image data as in the first mode is less than a curl amount in a case where printing is performed using the image data in the first mode.
